(19) United States
(12) Patent Application Publication
(10) Pub. No.: US 2025/0306532 A1
(43) Pub. Date: Oct. 2, 2025

(54) SWITCH MECHANISM, TIMEPIECE MOVEMENT, AND TIMEPIECE

(71) Applicant: SEIKO WATCH KABUSHIKI KAISHA (trading as SEIKO WATCH CORPORATION), Tokyo (JP)

(72) Inventors: Ken SATO, Tokyo (JP); Masayuki KAWATA, Tokyo (JP); Katsuya MUGISHIIMA, Tokyo (JP); Junya MASUDA, Tokyo (JP)

(21) Appl. No.: 19/083,179

(22) Filed: Mar. 18, 2025

(30) Foreign Application Priority Data
Mar. 27, 2024 (JP) 2024-051774

(51) Int. Cl. G04B 3/04

(52) U.S. Cl. CPC G04B 3/046

(57) ABSTRACT

Provided is a switch mechanism capable of improving a degree of freedom of a component layout in the vicinity of a winding stem while preventing an increase in thickness of a timepiece movement. The switch mechanism includes: a winding stem supported by a main plate; a lever side gear provided rotatably with respect to the main plate, having a first rotation axis extending in an up-down direction, and configured to rotate in conjunction with rotation of the winding stem; a circuit block having a first contact point and a second contact point; a switch lever formed to be detachably engaged with a tooth of the lever side gear and swingable according to rotation of the lever side gear, configured to swing from a predetermined swing center position to a first side to come into contact with the first contact point, and configured to swing from the swing center position to a second side to come into contact with the second contact point; and a return spring configured to bias the switch lever toward the swing center position.

### RELATED APPLICATIONS

This application claims priority to Japanese Patent application Nos. JP2024-051774, filed on Mar. 27, 2024, the entire content of which is incorporated herein by reference.

### BACKGROUND OF THE INVENTION

### 1. Field of the Invention

The present invention relates to a switch mechanism, a timepiece movement, and a timepiece.

### 2. Description of the Related Art

Electronic timepieces in the related art perform time correction and the like by causing crowns to rotate as in mechanical timepieces. In this type of the electronic timepiece, a switch lever is swung by a cam provided on a winding stem, and the lever is brought into contact with and separated from a contact point on a circuit block, thereby determining a rotation direction and a rotation speed of the crown and the winding stem, and controlling a motor for driving a timepiece hand and the like (for example, see PTL 1 and PTL 2). A method for detecting rotation of a winding stem by irradiating, with light of an optical sensor, a rotation body rotating in conjunction with the rotation of the winding stem has been developed (for example, see PTL 3).

### 3. Citations

### [Patent Literature]

PTL 1: JPS58-038504Y

PTL 2: JPS60-025595Y

PTL 3: JP7096383B

However, in a mechanism in the related art in which a switch lever is swung by a cam, it is necessary to dispose of the switch lever at a position where the switch lever is engaged with the cam, so that the arrangement of the switch lever is limited. Therefore, there is room for improvement in the degree of freedom of a component layout in the vicinity of the winding stem. In the method for detecting the rotation of the winding stem by the optical sensor, it is necessary to dispose of the optical sensor at a position overlapping the rotation body in a plan view, and a movement is likely to become thick.

### SUMMARY OF THE INVENTION

Therefore, it is an aspect of the present application to provide a switch mechanism capable of improving a degree of freedom of a component layout in the vicinity of a winding stem while preventing an increase in thickness of a timepiece movement, the timepiece movement including the switch mechanism, and a timepiece.

A switch mechanism according to a first aspect of the application includes: a winding stem supported by a main plate; a first gear provided rotatably with respect to the main plate, having a rotation axis extending in a timepiece front-back direction, and configured to rotate in conjunction with rotation of the winding stem; a circuit block having a first contact point and a second contact point; a lever formed to be detachably engaged with a tooth of the first gear and swingable according to rotation of the first gear, configured to swing from a predetermined center position toward a first side to come into contact with the first contact point, and configured to swing from the center position toward a second side to come into contact with the second contact point; and a return spring configured to bias the lever toward the center position.

According to the first aspect, when the switch mechanism is formed to swing the lever according to the rotation of the first gear, it is sufficient that the lever may be engaged with the tooth of the first gear. Therefore, the lever can be disposed at any position around the rotation axis on the periphery of the first gear without changing a shape of the lever. Accordingly, a degree of freedom of a component layout in the vicinity of the winding stem can be improved. In addition, in order to detachably engage the lever with the tooth of the first gear, the lever is disposed to be displaced in a direction orthogonal to the timepiece front-back direction with respect to the first gear, and thus it is possible to prevent an increase in thickness of a timepiece movement caused by providing the switch mechanism. As described above, it is possible to provide the switch mechanism capable of improving the degree of freedom of the component layout in the vicinity of the winding stem while preventing the increase in the thickness of the timepiece movement. Since the switch mechanism corresponds to the component layout having a plurality of patterns in the vicinity of the winding stem, the switch mechanism can be mounted on many kinds of the timepiece movement. Accordingly, it is possible to reduce manufacturing cost of the timepiece movement by sharing the components of the switch mechanism on a plurality of kinds of the timepiece movement.

The switch mechanism according to a second aspect of the application directed to the switch mechanism according to the first aspect may further include: a second gear disposed coaxially with the winding stem and formed to be rotatable integrally with the winding stem in a state of meshing with the first gear.

According to the second aspect, the first gear can be rotated in conjunction with the rotation of the winding stem. Accordingly, the switch mechanism having the above-described functions and effects is obtained.

The switch mechanism according to a third aspect of the application directed to the switch mechanism according to the first aspect or the second aspect may further include: an engagement portion in which the tooth and the lever are engaged with each other, in which the lever may be formed to be swingable around a swing axis extending in the timepiece front-back direction, and a distance between the rotation axis and the engagement portion may be larger than a distance between the swing axis and the engagement portion.

According to the third aspect, it is possible to increase a swing angle of the lever when the first gear rotates by one tooth, compared to a case where the distance between the rotation axis and the engagement portion is equal to or less than the distance between the swing axis and the engagement portion. Accordingly, a portion of the lever that comes into contact with the contact point of the circuit block can be largely displaced when the lever is swung without increasing a size of the lever, and the lever can be reliably brought into contact with and separated from the contact point. Accordingly, it is possible to prevent an increase in the size of the lever and improve the degree of freedom of the component layout in the vicinity of the winding stem.

The switch mechanism according to a fourth aspect of the application directed to the switch mechanism according to any one of the first aspect to the third aspect may further include: a wheel bridge disposed on an opposite side of the main plate with the first gear sandwiched therebetween, in which the circuit block may be disposed on the opposite side of the main plate with the lever sandwiched therebetween so as not to further protrude to the opposite side of the main plate than the wheel bridge in the timepiece front-back direction.

According to the fourth aspect, by using a member thinner than the circuit block in the timepiece front-back direction as the wheel bridge, the timepiece movement can be formed thin, as compared with a configuration in which the circuit block is disposed on the opposite side of the main plate with the first gear sandwiched therebetween. Accordingly, it is possible to prevent the increase in the thickness of the timepiece movement.

In the switch mechanism according to a fifth aspect of the application directed to the switch mechanism according to any one of the first aspect to the fourth aspect, the lever and the return spring may be formed separately from each other.

According to the fifth aspect, the lever and the return spring can be formed of different materials. Accordingly, for example, stainless steel having a high Young's modulus can be used for the return spring, and a material having a workability higher than the material of the return spring can be used for the lever. Accordingly, a desired performance can be easily imparted to the switch mechanism.

In the switch mechanism according to a sixth aspect of the application directed to the switch mechanism according to any one of the first aspect to the fifth aspect, the lever and the return spring may be formed integrally with each other.

According to the sixth aspect, as compared with a configuration in which the lever and the return spring are formed separately from each other, the number of components can be reduced, and the manufacturing cost can be reduced.

A timepiece movement according to a seventh aspect of the application includes the switch mechanism according to any one of the first aspect to the sixth aspect.

According to the seventh aspect, the timepiece movement includes the switch mechanism capable of preventing the increase in the thickness of the timepiece movement, and thus the timepiece movement can be suitable for a thin timepiece. Since the switch mechanism can be mounted on many kinds of the timepiece movement, component cost of the switch mechanism is reduced, and thus it is possible to provide the timepiece movement in which the manufacturing cost is reduced.

A timepiece according to an eighth aspect of the application includes the timepiece movement according to the seventh aspect.

According to the eighth aspect, a thin and inexpensive timepiece can be provided.

According to the application, it is possible to provide the switch mechanism capable of improving the degree of freedom of the component layout in the vicinity of the winding stem while preventing the increase in the thickness of the timepiece movement.

### BRIEF DESCRIPTION OF THE DRAWINGS

FIG. 1 is an external view of a timepiece according to an embodiment.

FIG. 2 is a perspective view showing a part of a movement according to a first embodiment.

FIG. 3 is an exploded perspective view showing the part of the movement according to the first embodiment.

FIG. 4 is a plan view showing a part of a switch mechanism according to the first embodiment.

FIG. 5 is a cross-sectional view of the movement according to the first embodiment, and shows a cross section taken at a position corresponding to a line V-V of FIG. 4.

FIG. 6 is a diagram showing an operation of the switch mechanism according to the first embodiment.

FIG. 7 is a plan view showing another example of the movement including the switch mechanism according to the first embodiment.

FIG. 8 is a plan view showing another example of the movement including the switch mechanism according to the first embodiment.

FIG. 9 is a plan view showing another example of the movement including the switch mechanism according to the first embodiment.

FIG. 10 is a perspective view showing a part of a movement according to a second embodiment.

FIG. 11 is an exploded perspective view showing the part of the movement according to the second embodiment.

FIG. 12 is a cross-sectional view of the movement according to the second embodiment and is a view corresponding to FIG. 5.

FIG. 13 is a plan view showing a part of a switch mechanism according to a third embodiment.

FIG. 14 is a diagram showing an operation of the switch mechanism according to the third embodiment.

FIG. 15 is a diagram showing an operation of the switch mechanism according to the third embodiment.

FIG. 16 is a plan view showing a part of a switch mechanism according to a fourth embodiment.

FIG. 17 is a cross-sectional view of a movement according to the fourth embodiment and is a view corresponding to FIG. 5.

FIG. 18 is a plan view showing a part of a switch mechanism according to a fifth embodiment.

### DETAILED DESCRIPTION OF THE PREFERRED EMBODIMENTS

Hereinafter, embodiments of the invention will be described with reference to the drawings. In the following description, components having the same or similar functions are denoted by the same reference signs. A redundant description of the components may be omitted.

First, a timepiece according to an embodiment will be described. In the embodiment described below, an analog electronic timepiece is exemplified as an example of the timepiece.

In general, a machine body including a driving portion of the timepiece is referred to as a “movement”. A state in which a dial and hands are attached to the movement and the obtained product is put into a timepiece case to form a finished product is referred to as a “complete” timepiece. A direction of a rotation axis of the hands is referred to as an up-down direction (timepiece front-back direction). Description will be made with a direction from a main plate which is a board of the timepiece toward a case back being an upper side and an opposite side thereof being a lower side in the up- down direction. A direction orthogonal to the up-down direction is referred to as a planar direction.

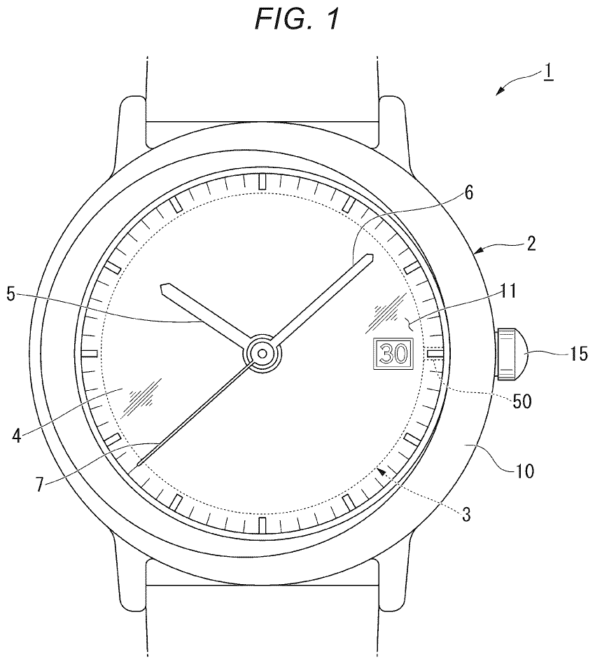

FIG. 1 is an external view of the timepiece according to the embodiment.

As shown in FIG. 1, a complete timepiece 1 according to the embodiment includes a movement 3 (timepiece movement), a dial 4, and hands including an hour hand 5, a minute hand 6, and a seconds hand 7 in a timepiece case 2. The dial 4 has indicators and the like indicating information related to at least hour.

The timepiece case 2 includes a case body 10, a case back (not shown), and a cover glass 11. In a side surface of the case body 10, a crown 15 is provided at a 3 o'clock position. The crown 15 is for operating the movement 3 from the outside of the case body 10. The crown 15 is fixed to a winding stem 50 inserted into the case body 10.

### First Embodiment

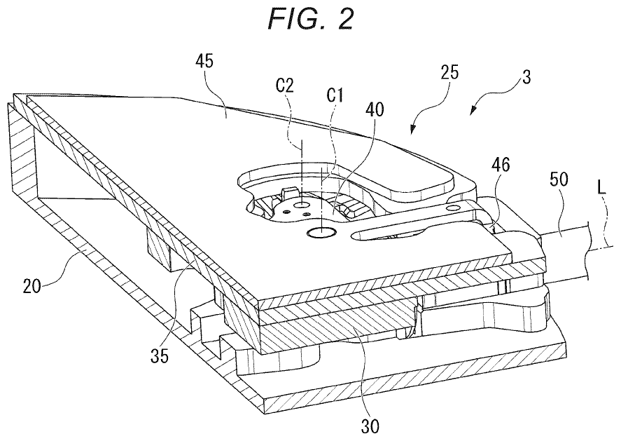

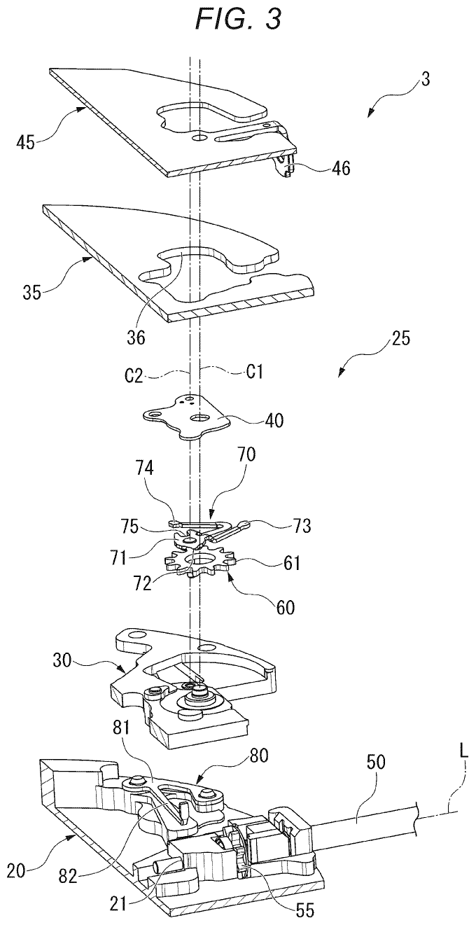

FIG. 2 is a perspective view showing a part of a movement according to a first embodiment. FIG. 3 is an exploded perspective view showing the part of the movement according to the first embodiment.

As shown in FIGS. 2 and 3, the movement 3 according to the first embodiment includes a main plate 20 and a switch mechanism 25 supported by the main plate 20. The main plate 20 forms a board of the movement 3. The main plate 20 is formed of, for example, a metal material or a resin material. The main plate 20 has a circular shape in a plan view when viewed from the up-down direction. The dial 4 described above is disposed on a lower side of the main plate 20. The switch mechanism 25 is disposed on an upper side of the main plate 20.

The switch mechanism 25 includes a train wheel bridge 30, a wheel bridge 40, a circuit block 35, a circuit block holder 45, the winding stem 50, a winding stem side gear 55 (second gear), a lever side gear 60 (first gear), a switch lever 70, and a return spring 80.

The train wheel bridge 30 is a member that spreads in the planar direction. The train wheel bridge 30 is disposed on the upper side of the main plate 20 in a state in which front and rear surfaces are directed in the up-down direction.

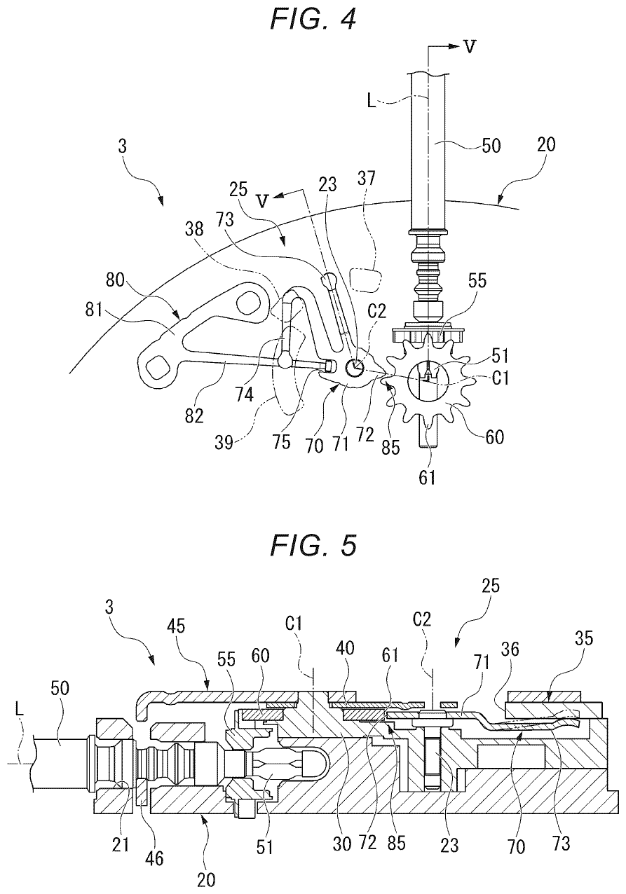

The circuit block 35 is a printed board. The circuit block 35 is disposed on the upper side of the main plate 20 in a state in which the front and rear surfaces are directed in the up-down direction. The circuit block 35 is disposed on an opposite side of the main plate 20 with the train wheel bridge 30 sandwiched therebetween in the up-down direction. The circuit block 35 is formed with a window portion 36 penetrating in the up-down direction. A first contact point 37, a second contact point 38, and a third contact point 39 are formed on a lower surface of the circuit block 35 (see FIG. 4). Formation positions of the contact points 37, 38, and 39 will be described later.

The wheel bridge 40 is a flat plate-shaped member that spreads in the planar direction. The wheel bridge 40 is formed thinner than the board of the circuit block 35. The wheel bridge 40 is disposed on the upper side of the main plate 20 in a state in which the front and rear surfaces are directed in the up-down direction. The wheel bridge 40 is disposed on the opposite side of the main plate 20 with the train wheel bridge 30 sandwiched therebetween in the up-down direction. The entire wheel bridge 40 is disposed inside the window portion 36 of the circuit block 35 in the plan view. An upper surface of the wheel bridge 40 is positioned above an upper surface of the circuit block 35. Accordingly, the circuit block 35 is disposed so as not to further protrude to the opposite side (that is, the upper side) of the main plate 20 than the wheel bridge 40 in the up-down direction. At least a part of the wheel bridge 40 is disposed within a thick range of the board of the circuit block 35 in the up-down direction so as to overlap the circuit block 35 in the planar direction.

The circuit block holder 45 is a plate-shaped member. The circuit block holder 45 is disposed on the opposite side of the main plate 20 with the circuit block 35 sandwiched therebetween in the up-down direction. The circuit block holder 45 is disposed so as to overlap the circuit block 35 and the wheel bridge 40 from above. The case back of the timepiece case 2 is disposed on an upper side of the circuit block holder 45 so as to directly face the circuit block holder 45.

The circuit block holder 45 includes a winding stem contact portion 46 that is in contact with the winding stem 50. The winding stem contact portion 46 extends downward from an outer edge of the circuit block holder 45 in the plan view. A through-hole through which the winding stem 50 is inserted is formed in the winding stem contact portion 46 (see FIG. 5). The winding stem contact portion 46 is in sliding contact with an outer peripheral surface of the winding stem 50 to generate a click feeling when displacing the winding stem 50 in an axis L direction.

The winding stem 50 is inserted into a winding stem guide hole 21 formed in the main plate 20. The winding stem 50 is rotatable around the axis L with respect to the main plate 20 and is movable in the axis L direction. The crown 15 is connected to the winding stem 50 outside the timepiece case 2 shown in FIG. 1. The winding stem 50 is movable in the axis L direction according to a pulling operation of the crown 15. In the embodiment, the winding stem 50 is movable between two positions, that is, a normal position where the winding stem 50 is most inserted into the movement 3 and an operation position where the winding stem 50 is pulled out from the normal position. An engagement shaft portion 51 having a non-circular cross-sectional shape is formed in the winding stem 50. The engagement shaft portion 51 has a prismatic shape extending in an axial direction of the winding stem 50. The engagement shaft portion 51 has a rectangular cross-sectional shape.

FIG. 4 is a plan view showing a part of a switch mechanism according to the first embodiment. FIG. 5 is a cross-sectional view of the movement according to the first embodiment, and shows a cross section taken at a position corresponding to a line V-V of FIG. 4. FIG. 4 shows a state in which components overlapping movable components of the switch mechanism are removed (the same applies to other plan views). Further, in FIG. 4, the contact points 37, 38, and 39 of the circuit block 35 are indicated by imaginary lines.

As shown in FIGS. 4 and 5, the winding stem side gear 55 is inserted around the winding stem 50 and is disposed coaxially with the axis L. The winding stem side gear 55 is separated from the engagement shaft portion 51 of the winding stem 50 at the normal position and is rotatable with respect to the winding stem 50. The winding stem side gear 55 engages with the engagement shaft portion 51 of the winding stem 50 at the operation position and is rotatable integrally with the winding stem 50.

The lever side gear 60 is disposed on the upper side of the main plate 20. The lever side gear 60 is provided rotatably with respect to the main plate 20. The lever side gear 60 has a first rotation axis C1 extending in the up-down direction. The first rotation axis C1 is orthogonal to the axis L of the winding stem 50. The lever side gear 60 is disposed between the main plate 20 and the wheel bridge 40. In the embodiment, the lever side gear 60 is disposed between the train wheel bridge 30 and the wheel bridge 40 and is rotatably supported by the train wheel bridge 30. An upper surface of the lever side gear 60 directly faces a lower surface of the wheel bridge 40. The upper surface of the lever side gear 60 is positioned below the upper surface of the board of the circuit block 35. At least a part of the lever side gear 60 is disposed within the thickness range of the board of the circuit block 35 in the up-down direction so as to overlap the circuit block 35 in the planar direction. The lever side gear 60 is disposed closer to a center of the movement 3 than the winding stem side gear 55. The lever side gear 60 meshes with the winding stem side gear 55. Accordingly, the lever side gear 60 is rotatable in conjunction with the rotation of the winding stem 50.

The switch lever 70 is disposed on the upper side of the main plate 20. The switch lever 70 is disposed to be swingable in the planar direction around an axis C2 (swing axis) extending in the up-down direction with respect to the main plate 20. The switch lever 70 is disposed to be swingable in two directions from a predetermined swing center position shown in FIG. 4. The switch lever 70 pivots from the swing center position to a first swing end position on a first side. The switch lever 70 pivots from the swing center position to a second swing end position on a second side. Hereinafter, unless otherwise specified, the switch lever 70 is positioned at the predetermined swing center position.

The switch lever 70 is disposed between the main plate 20 and each of the wheel bridge 40 and the circuit block 35. In the embodiment, the switch lever 70 is disposed from between the train wheel bridge 30 and the wheel bridge 40 to between the train wheel bridge 30 and the circuit block 35. The switch lever 70 is disposed to be displaced from the lever side gear 60 in the planar direction so that the entire switch lever 70 does not overlap the lever side gear 60 in the plan view. The switch lever 70 is supported by a lever shaft 23 held by the train wheel bridge 30. The switch lever 70 is formed of a conductive member such as a metal.

The switch lever 70 includes a base portion 71 supported by the lever shaft 23, an engagement finger 72 protruding from the base portion 71 toward the lever side gear 60 and engaged with teeth 61 of the lever side gear 60, and a first arm 73 and a second arm 74 extending from the base portion 71 in the planar direction. The base portion 71 is formed in a flat plate shape spreading in the planar direction. The base portion 71 is disposed in a state in which the front and rear surfaces thereof are directed in the up-down direction. The entire base portion 71 is disposed within a thick range of the lever side gear 60 in the up-down direction so as to overlap the lever side gear 60 in the planar direction. At least a part of the base portion 71 is disposed within the thick range of the board of the circuit block 35 in the up-down direction so as to overlap the circuit block 35 in the planar direction. The engagement finger 72 enters a tooth groove of the lever side gear 60.

The first arm 73 extends from the base portion 71 in a direction away from the lever side gear 60 in the plan view. The first arm 73 is bent downward from the base portion 71 and extends to a space below the circuit block 35. A tip end of the first arm 73 is in sliding contact with the lower surface of the circuit block 35. The tip end of the first arm 73 is in contact with the first contact point 37 when the switch lever 70 is at the first swing end position. The tip end of the first arm 73 separates from the first contact point 37 when the switch lever 70 moves from the first swing end position toward the swing center position. The tip end of the first arm 73 is in contact with the second contact point 38 when the switch lever 70 is at the second swing end position. The tip end of the first arm 73 separates from the second contact point 38 when the switch lever 70 moves from the second swing end position toward the swing center position.

The second arm 74 is disposed to be displaced from the first arm 73 in the planar direction. The second arm 74 extends from the base portion 71 in the direction away from the lever side gear 60 in the plan view. The second arm 74 is bent downward from the base portion 71 and extends to the space below the circuit block 35. In the shown example, the second arm 74 is formed in a U-shape in the plan view, but the shape of the second arm 74 is not particularly limited. A tip end of the second arm 74 is in sliding contact with the lower surface of the circuit block 35. The tip end of the second arm 74 is in contact with the third contact point 39 when the switch lever 70 is at the first swing end position and at the second swing end position. In the embodiment, the tip end of the second arm 74 is also in contact with the third contact point 39 when the switch lever 70 is at any position between the first swing end position and the second swing end position. In this case, the third contact point 39 continuously extends in a circumferential direction around the lever shaft 23 in the plan view.

The switch lever 70 is formed with an engaged portion 75 with which the return spring 80 is engaged. In the embodiment, the engaged portion 75 is a notch formed in a side surface of the base portion 71. The engaged portion 75 is formed at a position on the base portion 71 facing a side opposite to the lever side gear 60.

Here, a portion where the teeth 61 of the lever side gear 60 and the engagement finger 72 of the switch lever 70 are engaged with each other is referred to as an engagement portion 85. A distance between the first rotation axis C1 and the engagement portion 85 is larger than a distance between the axis C2 and the engagement portion 85. The distance between the axis C2 and the engagement portion 85 is smaller than a distance between the axis C2 and the tip end of the first arm 73.

The return spring 80 is engaged with the engaged portion 75 of the switch lever 70 so as to bias the switch lever 70 toward the swing center position. The return spring 80 includes a spring base portion 81 fixed to the main plate 20 and a spring portion 82 connecting the spring base portion 81 and the switch lever 70 to each other. The spring base portion 81 is disposed between the main plate 20 and the train wheel bridge 30. The spring base portion 81 is disposed on the opposite side of the lever side gear 60 with the base portion 71 of the switch lever 70 sandwiched therebetween in the plan view.

The spring portion 82 extends from the spring base portion 81 toward the switch lever 70. The spring portion 82 is formed in a rod shape having a width sufficiently smaller than the entire length thereof, and is deflectable and deformable in the planar direction. The spring portion 82 extends in the planar direction on the main plate 20 side (lower side) of the switch lever 70 in the up-down direction. The spring portion 82 is disposed to overlap a swing trajectory of the switch lever 70 in the plan view. The spring portion 82 passes below the second arm 74 of the switch lever 70. A tip end of the spring portion 82 is bent upward and is engaged with the engaged portion 75 of the switch lever 70.

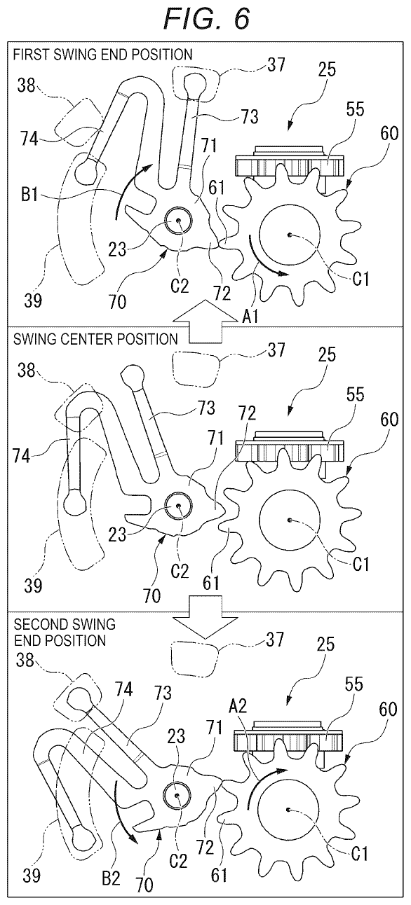

An operation of the switch mechanism 25 according to the embodiment will be described with reference to FIG. 6.

FIG. 6 is a diagram showing the operation of the switch mechanism according to the first embodiment. When the winding stem 50 at the operation position is rotated in the first direction, the lever side gear 60 rotates in a direction A1 as shown in FIG. 6. When the lever side gear 60 is rotated in the direction A1, the switch lever 70 having the engagement finger 72 meshing with the lever side gear 60 pivots in a direction B1 from the swing center position against a biasing force of the return spring 80. When the rotation of the lever side gear 60 in the direction A1 progresses, the engagement finger 72 climbs over the teeth 61 of the lever side gear 60, and the switch lever 70 pivots in a direction B2 opposite to the direction B1 toward the swing center position due to an elastic restoring force of the return spring 80. Accordingly, by rotating the winding stem 50 at the operation position in the first direction, the switch lever 70 swings so as to reciprocate between the swing center position and the first swing end position.

When the winding stem 50 at the operation position is rotated in a second direction, the lever side gear 60 rotates in a direction A2. When the lever side gear 60 is rotated in the direction A2, the switch lever 70 having the engagement finger 72 meshing with the lever side gear 60 pivots in the direction B2 from the swing center position against the biasing force of the return spring 80. When the rotation of the lever side gear 60 in the direction A2 progresses, the engagement finger 72 climbs over the teeth 61 of the lever side gear 60, and the switch lever 70 pivots in the direction B1 toward the swing center position due to the elastic restoring force of the return spring 80. Accordingly, by rotating the winding stem 50 at the operation position in the second direction, the switch lever 70 swings so as to reciprocate between the swing center position and the second swing end position.

When the switch lever 70 is at the first swing end position, the tip end of the first arm 73 of the switch lever 70 is in contact with the first contact point 37, and the first contact point 37 and the third contact point 39 are electrically connected via the switch lever 70. When the switch lever 70 is at the second swing end position, the tip end of the first arm 73 of the switch lever 70 is in contact with the second contact point 38, and the second contact point 38 and the third contact point 39 are electrically connected via the switch lever 70. By rotating the winding stem 50 at the operation position in the first direction, the tip end of the first arm 73 of the switch lever 70 comes into contact with and separates from the first contact point 37 in a cycle corresponding to a rotation speed of the winding stem 50, and the first contact point 37 and the third contact point 39 repeat conduction and insulation in the cycle corresponding to the rotation speed of the winding stem 50. By rotating the winding stem 50 at the operation position in the second direction, the tip end of the first arm 73 of the switch lever 70 comes into contact with and separates from the second contact point 38 in the cycle corresponding to the rotation speed of the winding stem 50, and the second contact point 38 and the third contact point 39 repeat conduction and insulation in the cycle corresponding to the rotation speed of the winding stem 50.

As described above, the switch mechanism 25 according to the embodiment includes: the lever side gear 60 that rotates in conjunction with the rotation of the winding stem 50; the circuit block 35 that has the first contact point 37 and the second contact point 38; the switch lever 70 that is formed to be detachably engaged with the teeth 61 of the lever side gear 60 and swingable according to the rotation of the lever side gear 60, swings in the direction B1 from the swing center position and comes into contact with the first contact point 37, and swings in the direction B2 from the swing center position to come into contact with the second contact point 38; and the return spring 80 that biases the switch lever 70 toward the swing center position. According to this configuration, when the switch mechanism 25 is formed to swing the switch lever 70 according to the rotation of the lever side gear 60, it is sufficient that the switch lever 70 may be engaged with the teeth 61 of the lever side gear 60. Therefore, the switch lever 70 can be disposed at any position around the first rotation axis C1 on the periphery of the lever side gear 60 without changing the shape of the switch lever 70.

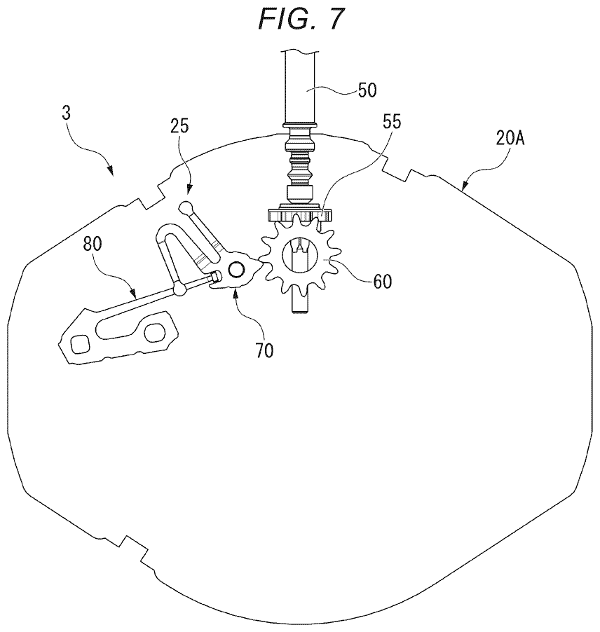

For example, as shown in FIG. 7, when a main plate 20A has a non-circular shape having an outer shape smaller than the main plate 20 according to the first embodiment, the switch lever 70 and the return spring 80 can be disposed closer to the center of the movement 3 so as to avoid an outline of the main plate 20A in the plan view.

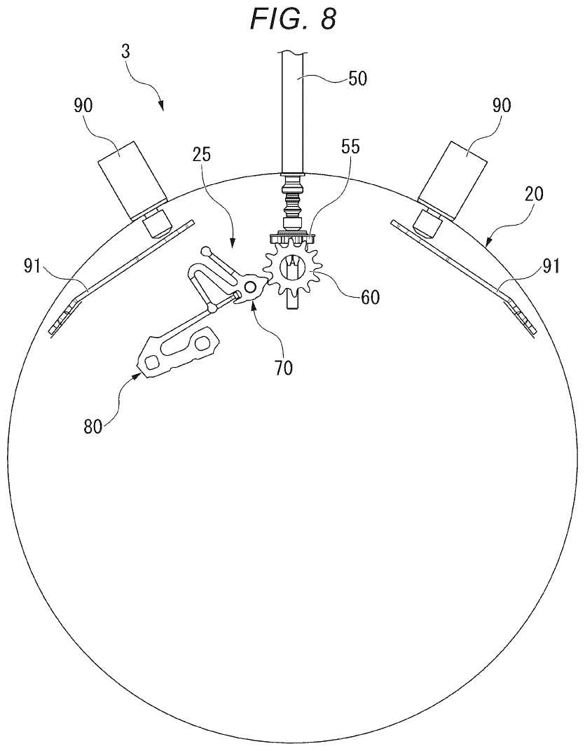

As shown in FIG. 8, when a button 90 is provided to be adjacent to the winding stem 50, the switch lever 70 and the return spring 80 can be disposed closer to the center of the movement 3 so as to avoid a switch spring 91 and the like forming a contact point with the button 90.

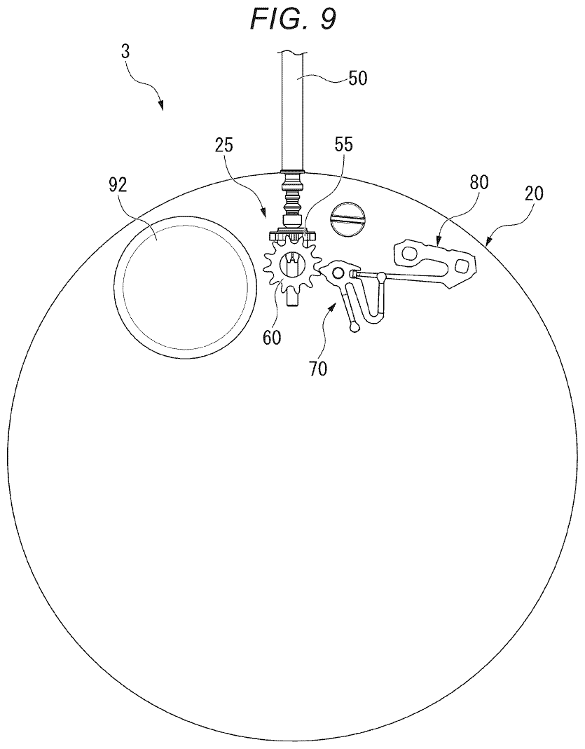

As shown in FIG. 9, when a battery 92 is disposed to be adjacent to the winding stem 50 in the plan view, the switch lever 70 and the return spring 80 can be disposed on an opposite side of the battery 92 with the winding stem 50 sandwiched therebetween so as to avoid the battery 92.

Accordingly, the degree of freedom of the component layout in the vicinity of the winding stem 50 can be improved. In addition, in order to detachably engage the switch lever 70 with the teeth 61 of the lever side gear 60, the switch lever 70 is disposed to be displaced in the planar direction with respect to the lever side gear 60, and thus it is possible to prevent an increase in thickness of the movement 3 caused by providing the switch mechanism 25. As described above, it is possible to provide the switch mechanism 25 capable of improving the degree of freedom of the component layout in the vicinity of the winding stem 50 while preventing the increase in the thickness of the movement 3.

Since the switch mechanism 25 corresponds to the component layout having a plurality of patterns in the vicinity of the winding stem 50, the switch mechanism 25 can be mounted on many kinds of the movement 3. Accordingly, it is possible to reduce the manufacturing cost of the movement 3 by sharing the components of the switch mechanism 25 on a plurality of kinds of the movement 3.

The switch mechanism 25 further includes the winding stem side gear 55 that is disposed coaxially with the winding stem 50 and is formed to be rotatable integrally with the winding stem 50 in a state of meshing with the lever side gear 60. According to this configuration, the lever side gear 60 can be rotated in conjunction with the rotation of the winding stem 50. Accordingly, the switch mechanism 25 having the above-described functions and effects is obtained.

The switch mechanism 25 includes the engagement portion 85 in which the teeth 61 of the lever side gear 60 and the switch lever 70 are engaged with each other. The distance between the first rotation axis C1 of the lever side gear 60 and the engagement portion 85 is larger than the distance between the axis C2 of the switch lever 70 and the engagement portion 85. According to this configuration, it is possible to increase a swing angle of the switch lever 70 when the lever side gear 60 rotates by one tooth, compared to a case where the distance between the first rotation axis C1 and the engagement portion 85 is equal to or less than the distance between the axis C2 and the engagement portion 85. Accordingly, a portion of the switch lever 70 (the tip end of the first arm 73) that comes into contact with the contact points 37 and 38 of the circuit block 35 can be largely displaced when the switch lever 70 is swung without increasing a size of the switch lever 70, and the switch lever 70 can be reliably brought into contact with and separated from the contact points 37 and 38. Accordingly, it is possible to prevent an increase in the size of the switch lever 70 and improve the degree of freedom of the component layout in the vicinity of the winding stem 50.

The switch mechanism 25 further includes the wheel bridge 40 disposed on the opposite side of the main plate 20 with the lever side gear 60 sandwiched therebetween. The circuit block 35 is disposed on the opposite side of the main plate 20 with the switch lever 70 sandwiched therebetween so as not to further protrude to the opposite side of the main plate 20 than the wheel bridge 40 in the up-down direction. According to this configuration, by using a member thinner than the circuit block 35 in the up-down direction as the wheel bridge 40, the movement 3 can be formed thin, as compared with a configuration in which the circuit block 35 is disposed on the opposite side of the main plate 20 with the lever side gear 60 sandwiched therebetween. Accordingly, it is possible to prevent an increase in the thickness of the movement 3.

The switch lever 70 and the return spring 80 are formed separately from each other. According to this configuration, the switch lever 70 and the return spring 80 can be formed of different materials. Accordingly, for example, stainless steel having a high Young's modulus can be used for the return spring 80, and a material having a workability higher than the material of the return spring 80 can be used for the switch lever 70. Accordingly, a desired performance can be easily imparted to the switch mechanism 25.

The movement 3 according to the embodiment includes the switch mechanism 25 described above, and thus the movement 3 can be suitable for the thin timepiece 1. Since the switch mechanism 25 can be mounted on many kinds of the movement 3, component cost of the switch mechanism 25 is reduced, and thus it is possible to provide the movement 3 in which the manufacturing cost is reduced.

### Second Embodiment

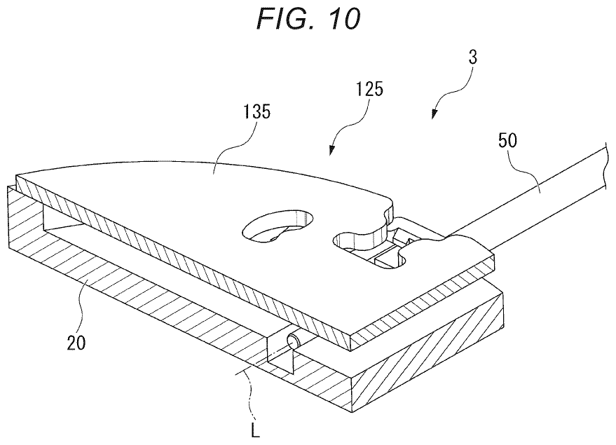

Next, a second embodiment will be described with reference to FIGS. 10 to 12. The second embodiment is different from the first embodiment in that a switch mechanism 125 does not include the train wheel bridge 30 and the wheel bridge 40 according to the first embodiment. Configurations other than those to be described below are similar as those of the first embodiment.

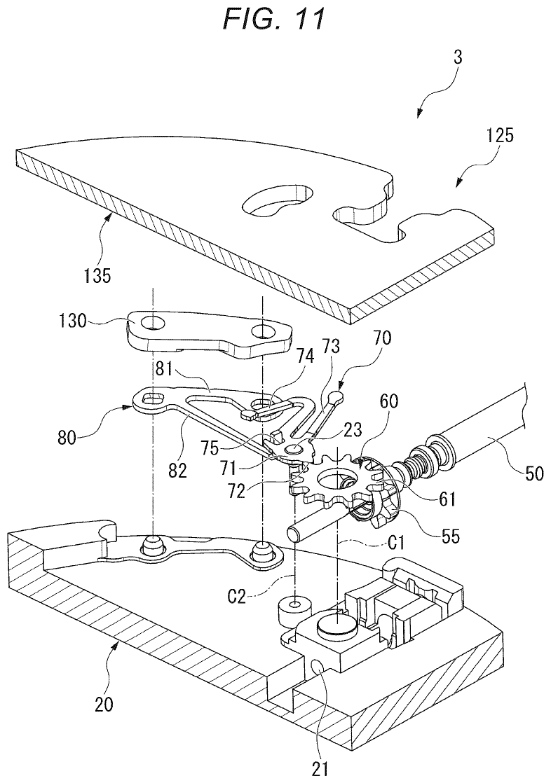

FIG. 10 is a perspective view showing a part of a movement according to the second embodiment. FIG. 11 is an exploded perspective view showing the part of the movement according to the second embodiment.

As shown in FIGS. 10 and 11, the switch mechanism 125 includes a spring bridge 130 and a circuit block 135 instead of the train wheel bridge 30, the wheel bridge 40, and the circuit block 35 according to the first embodiment. The spring bridge 130 and the circuit block 135 are disposed on the upper side of the main plate 20. The circuit block 135 is disposed on the opposite side of the main plate 20 with the spring bridge 130 sandwiched therebetween in the up-down direction. As in the first embodiment, a circuit block holder (not shown) may overlap the circuit block 135 from above.

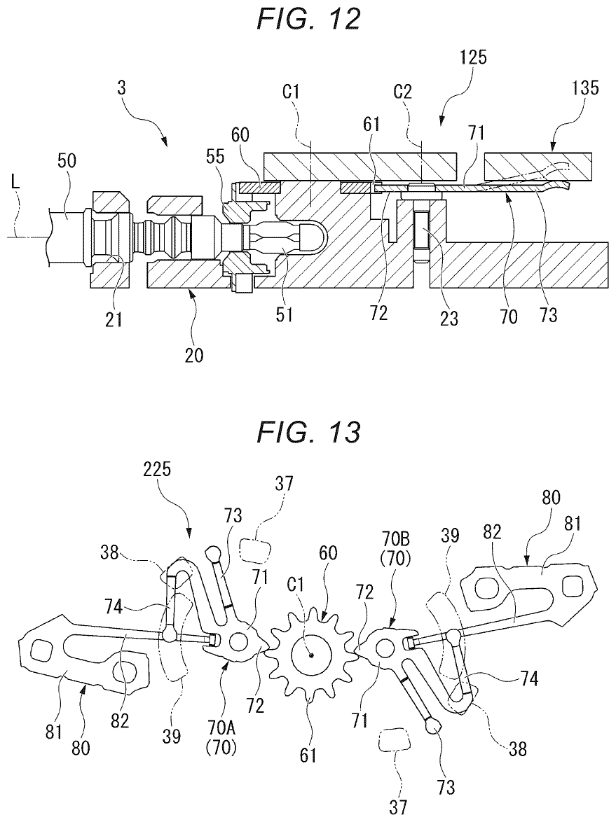

FIG. 12 is a cross-sectional view of the movement according to the second embodiment, and is a view corresponding to FIG. 5.

As shown in FIG. 12, the lever side gear 60 is disposed between the main plate 20 and the circuit block 135, and is rotatably supported by the main plate 20. The upper surface of the lever side gear 60 directly faces a lower surface of the circuit block 135. The switch lever 70 is disposed between the main plate 20 and the circuit block 135, and is supported by the lever shaft 23 held by the main plate 20. The spring base portion 81 of the return spring 80 is disposed between the main plate 20 and the spring bridge 130.

In the embodiment, a similar effect as that of the first embodiment is achieved. In addition, in the embodiment, since the circuit block 135 is disposed on the opposite side of the main plate 20 with the lever side gear 60 sandwiched therebetween, a bridge member (wheel bridge) for the lever side gear 60 can be omitted, the number of components can be reduced, and the manufacturing cost can be reduced.

### Third Embodiment

Next, a third embodiment will be described with reference to FIGS. 13 to 15. The third embodiment is different from the first embodiment in that a switch mechanism 225 includes a plurality of the switch levers 70. Configurations other than those to be described below are similar as those of the first embodiment.

FIG. 13 is a plan view showing a part of the switch mechanism according to the third embodiment.

As shown in FIG. 13, the switch mechanism 225 includes two switch levers 70 and the same number of return springs 80 as the switch levers 70. The two switch levers 70 are disposed to be displaced from each other in the planar direction on the periphery of the lever side gear 60. The engagement fingers 72 of the two switch levers 70 are disposed at positions displaced from each other by (n+0.5) teeth on the tooth tip circle of the lever side gear 60. Here, n is any natural number less than the number of teeth of the lever side gear 60. The return spring 80 is engaged with each switch lever 70. On the lower surface of the circuit block 35, two first contact points 37, two second contact points 38, and two third contact points 39 are provided corresponding to the respective switch levers 70. In the following description, one of the two switch levers 70 is referred to as a first switch lever 70A, and the other is referred to as a second switch lever 70B.

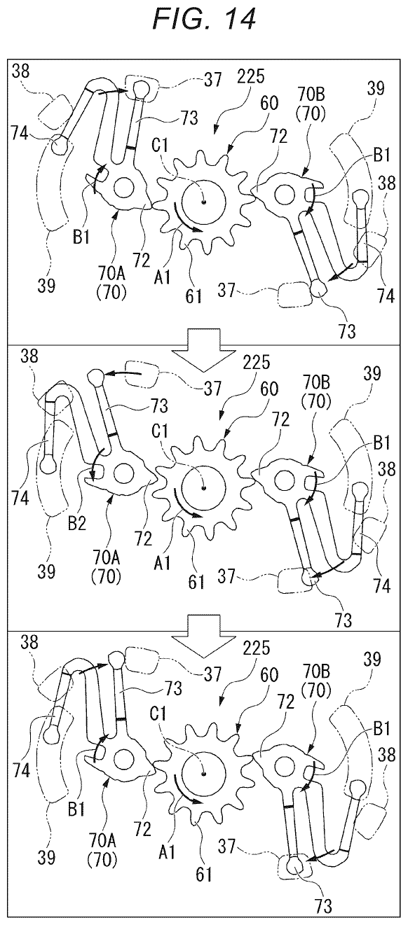

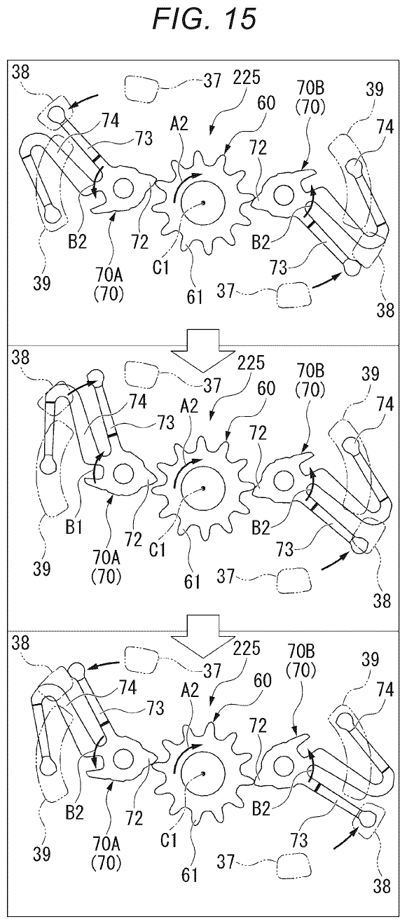

An operation of the switch mechanism 225 according to the embodiment will be described with reference to FIGS. 14 and 15. In the following description, description of an operation common to the operation of the switch mechanism 225 according to the first embodiment may be omitted or simplified.

FIGS. 14 and 15 are diagrams showing the operation of the switch mechanism according to the third embodiment.

As shown in FIG. 14, when the lever side gear 60 is rotated in the direction A1, the two switch levers 70 swing so as to reciprocate between the swing center position and the first swing end position, similarly to the switch lever 70 according to the first embodiment. The two switch levers 70 reciprocate once each time the lever side gear 60 rotates by one tooth in the direction A1. Here, the engagement fingers 72 of the two switch levers 70 are disposed at positions displaced from each other by (n+0.5) teeth, and alternately climb over the teeth 61 of the lever side gear 60. Therefore, the two switch levers 70 alternately reach the first swing end position and bring the tip end of the first arm 73 into contact with the first contact point 37 of the circuit block 35. Accordingly, by rotating the winding stem 50 at the operation position in the first direction, the first contact point 37 and the third contact point 39 repeat conduction and insulation in a half cycle of the first embodiment.

As shown in FIG. 15, when the lever side gear 60 is rotated in the direction A2, the two switch levers 70 swing so as to reciprocate between the swing center position and the second swing end position, similarly to the switch lever 70 according to the first embodiment. The two switch levers 70 reciprocate once each time the lever side gear 60 rotates by one tooth in the direction A2. The engagement fingers 72 of the two switch levers 70 alternately climb over the teeth 61 of the lever side gear 60, similarly to the case of rotating the lever side gear 60 in the direction A1. Therefore, the two switch levers 70 alternately reach the second swing end position and bring the tip end of the first arm 73 into contact with the second contact point 38 of the circuit block 35. Accordingly, by rotating the winding stem 50 at the operation position in the second direction, the second contact point 38 and the third contact point 39 repeat conduction and insulation in the half cycle of the first embodiment.

In the embodiment, a similar effect as that of the first embodiment is achieved. In addition, in the embodiment, the number of times of contact of the switch lever 70 with the contact points 37 and 38 of the circuit block 35 when the winding stem 50 is rotated can be increased. Accordingly, detection accuracy of the rotation of the winding stem 50 can be improved.

### Fourth Embodiment

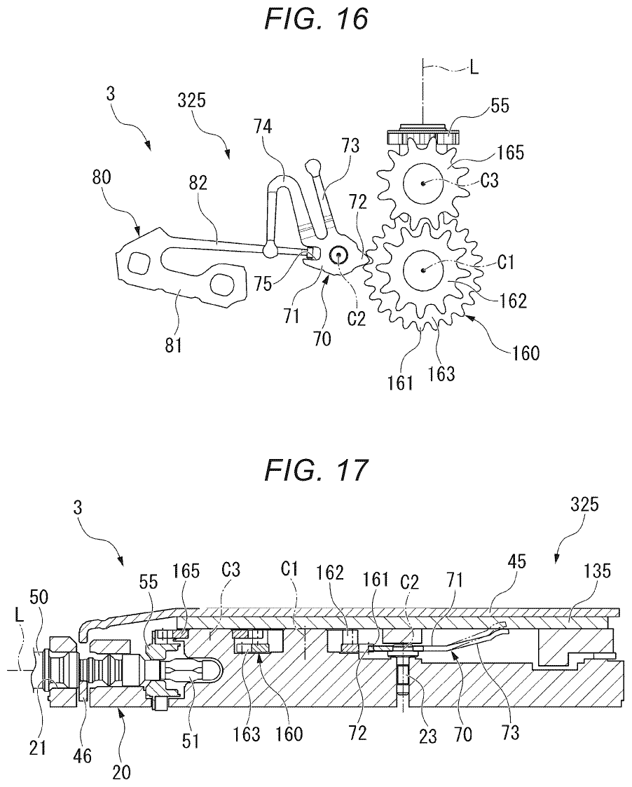

Next, a fourth embodiment will be described with reference to FIGS. 16 and 17. The fourth embodiment is different from the second embodiment in that a lever side gear 163 is provided as a two-stage gear. Configurations other than those to be described below are similar as those of the second embodiment.

FIG. 16 is a plan view showing a part of a switch mechanism according to the fourth embodiment. FIG. 17 is a cross-sectional view of a movement according to the fourth embodiment and is a view corresponding to FIG. 5.

As shown in FIGS. 16 and 17, a switch mechanism 325 includes an intermediate gear 165 and a lever side wheel 160 instead of the lever side gear 60 according to the first embodiment.

The intermediate gear 165 is disposed on the upper side of the main plate 20. The intermediate gear 165 is provided rotatably with respect to the main plate 20. The intermediate gear 165 has a second rotation axis C3 extending in the up-down direction. The second rotation axis C3 is orthogonal to the axis L of the winding stem 50. The intermediate gear 165 is disposed between the main plate 20 and the circuit block 135 and is rotatably supported by the main plate 20. The intermediate gear 165 meshes with the winding stem side gear 55.

The lever side wheel 160 is disposed between the main plate 20 and the circuit block 135 and is rotatably supported by the main plate 20. The lever side wheel 160 is a two-stage gear. The lever side wheel 160 includes a pinion 162 that meshes with the intermediate gear 165, and the lever side gear 163 having more teeth than that of the pinion 162. The lever side gear 163 is disposed on the main plate 20 side of the pinion 162. The lever side gear 163 overlaps the base portion 71 of the switch lever 70 in the planar direction. The engagement finger 72 of the switch lever 70 is engaged with teeth 161 of the lever side gear 163.

In the embodiment, a similar effect as that of the second embodiment is achieved. In addition, in the embodiment, the number of times that the engagement finger 72 of the switch lever 70 climbs over the teeth 161 of the lever side gear 163 when the winding stem 50 is rotated is increased, as compared with a configuration in which the lever side gear directly meshes with the winding stem side gear 55. Accordingly, the number of contact times of the switch lever 70 with the contact points 37 and 38 of the circuit block 135 when the winding stem 50 is rotated can be increased. Accordingly, detection accuracy of the rotation of the winding stem 50 can be improved.

### Fifth Embodiment

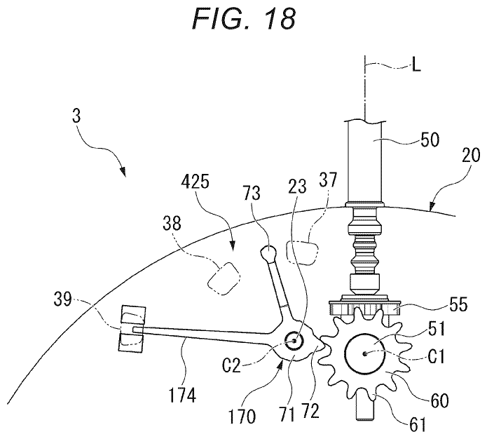

Next, a fifth embodiment will be described with reference to FIG. 18. The fifth embodiment is different from the first embodiment in that a return spring is provided in a switch lever 170 itself. Configurations other than those to be described below are similar as those of the first embodiment.

FIG. 18 is a plan view showing a part of a switch mechanism according to the fifth embodiment.

As shown in FIG. 18, a switch mechanism 425 includes the switch lever 170 instead of the switch lever 70 and the return spring 80 according to the first embodiment. A second arm 174 of the switch lever 170 extends from the base portion 71 in a direction away from the lever side gear 60 in the plan view. The second arm 174 extends linearly along a radial direction of the lever shaft 23 in the plan view. The second arm 174 is formed in a rod shape having a width sufficiently smaller than the entire length thereof and is deflectable and deformable in the planar direction. A tip end of the second arm 174 is in contact with the third contact point 39 of the circuit block 35 and is restricted from being displaced in the circumferential direction around the lever shaft 23 with respect to the main plate 20. Accordingly, the second arm 174 serves as a return spring and biases the base portion 71 of the switch lever 170 and the first arm 73 toward the swing center position.

In the embodiment, a similar effect as that of the first embodiment is achieved. In addition, in the embodiment, as compared with a configuration in which the switch lever and the return spring are formed separately from each other, the number of components can be reduced, and the manufacturing cost can be reduced.

The invention is not limited to the embodiments described above with reference to the drawings, and various modifications are conceivable within the technical scope of the invention.

For example, although the invention is applied to an analog electronic timepiece in the above embodiments, the invention is not limited to this configuration, and the invention may be applied to, for example, a digital electronic timepiece.

In the above embodiments, the winding stem side gear is a spur gear, but for example, the winding stem side gear may be a so-called crown gear.

In the above embodiments, the switch mechanism operates by rotating the winding stem at the operation position pulled out from the normal position, but the invention is not limited to this configuration. For example, the switch mechanism may operate by rotating the winding stem in the most pushed state.

In addition, the components in the above embodiments can be appropriately replaced with well-known components without departing from the gist of the invention, and the above embodiments and modifications may be appropriately combined.

What is claimed is:

1. A switch mechanism comprising:
a winding stem supported by a main plate;
a first gear provided rotatably with respect to the main plate, having a rotation axis extending in a timepiece front-back direction, and configured to rotate in conjunction with rotation of the winding stem;
a circuit block having a first contact point and a second contact point;
a lever formed to be detachably engaged with a tooth of the first gear and swingable according to rotation of the first gear, configured to swing from a predetermined center position toward a first side to come into contact with the first contact point, and configured to swing from the center position toward a second side to come into contact with the second contact point; and
a return spring configured to bias the lever toward the center position.

2. The switch mechanism according to claim 1, further comprising:
a second gear disposed coaxially with the winding stem and formed to be rotatable integrally with the winding stem in a state of meshing with the first gear.

3. The switch mechanism according to claim 1, further comprising:
an engagement portion in which the tooth and the lever are engaged with each other, wherein
the lever is formed to be swingable around a swing axis extending in the timepiece front-back direction, and
a distance between the rotation axis and the engagement portion is larger than a distance between the swing axis and the engagement portion.

4. The switch mechanism according to claim 1, further comprising:
a wheel bridge disposed on an opposite side of the main plate with the first gear sandwiched therebetween, wherein
the circuit block is disposed on the opposite side of the main plate with the lever sandwiched therebetween so as not to further protrude to the opposite side of the main plate than the wheel bridge in the timepiece front-back direction.

5. The switch mechanism according to claim 1, wherein
the lever and the return spring are formed separately from each other.

6. The switch mechanism according to claim 1, wherein
the lever and the return spring are formed integrally with each other.

7. A timepiece movement comprising:
the switch mechanism according to claim 1.

8. A timepiece comprising:
the timepiece movement according to claim 7.
